(19) United States
(12) Patent Application Publication
(10) Pub. No.: US 2017/0074804 A1
(43) Pub. Date: Mar. 16, 2017

(54) ELECTROMAGNETIC WAVE MEASUREMENT DEVICE, MEASUREMENT METHOD, PROGRAM, AND RECORDING MEDIUM

(71) Applicant: ADVANTEST CORPORATION, Tokyo (JP)

(72) Inventors: Fumikazu TAKAYANAGI, Miyagi (JP); Akiyoshi IRISAWA, Miyagi (JP)

(73) Assignee: ADVANTEST CORPORATION, Tokyo (JP)

(21) Appl. No.: 15/122,689

(22) PCT Filed: Apr. 21, 2015
(86) PCT No.: PCT/JP2015/062042

§ 371 Date: Aug. 31, 2016

Related U.S. Application Data
(60) Provisional application No. 61/982,463, filed on Apr. 22, 2014.

(51) Int. Cl. G01N 21/88; G01N 21/55; G01N 21/59

(52) U.S. Cl. CPC G01N 21/8806; G01N 21/59; G01N 21/55; G01N 2201/0696

(57) ABSTRACT

According to the present invention, an electromagnetic wave measurement device includes an electromagnetic wave output device and an electromagnetic wave detector. The electromagnetic wave output device outputs an electromagnetic wave having a frequency equal to or more than 0.01 [THz] and equal to or less than 100 [THz] toward a sample acquired by adhering a plurality of specimens to each other by an adhesive and a reflective body arranged behind the sample. The electromagnetic wave detector detects a reflected electromagnetic wave, which is the electromagnetic wave reflected by one of the sample and the reflective body. The electromagnetic wave measurement device determines whether a joint by the adhesive is excellent or not based on the detected reflected electromagnetic wave.

### FIELD OF THE INVENTION

The present invention relates to a measurement of a sample having a layered structure including at least two layers (such as paper and film) by lining an electromagnetic wave (frequency of which is equal to or more than 0.01 [THz], and equal to or less than 100 [THz]) (such as a terahertz wave (frequency of which is equal to or more than 0.03 [THz], and equal to or less than 10 [THz]), for example).

### BACKGROUND ART

Conventionally, a defective joint which is difficult to visually inspect occurs due to a defective application of an adhesive or an entrance of the air into an interface when specimens are joined to each other. As an example of a conventional inspection method for the defective joint caused by the non-contact manner, there in a transmission measurement by using a near infrared ray. The defective joint can be detected by irradiating a near infrared beam upon specimens, and monitoring a change in transmission light intensity caused by the adhesive.

### CITATION LISTS

### (Patent Literature 1) Japanese Laid-Open Patent Publication (Kokai) No. 2004-028618

### (Patent Literature 2) PCT Pamphlet WO2009/050830

### (Patent Literature 3) Japanese Laid-Open Patent Publication (Kokai) No. 2008-076159

### SUMMARY OF THE INVENTION

However, if the transmission intensity decreases depending on a thickness or a type of the specimens or the adhesive, the detection of the defective joint becomes difficult.

It is therefore an object of the present invention to lower the decrease in the transmission intensity depending on the thickness or the type of the specimens and the adhesive compared with the case of using the near infrared.

An electromagnetic wave measurement device according to the present invention is an device that monitors at least one of a spectrum, a pulse amplitude, and a pulse delay time of a transmitted wave or a reflected wave of an electromagnetic wave (such as terahertz wave) equal to or more than 0.01 [THz] and equal to or less than 100 [THz] in frequency made incident to a sample (specimens adhered to each other by an adhesive), and monitors at least one of a spectrum change, a pulse amplitude attenuation and a pulse delay tune change by the adhesive applied to the specimens.

The electromagnetic wave measurement device, according to the present invention may enable a mapping measurement of a defective joint by scanning the specimens or a sensor (an electromagnetic wave generator and an electromagnetic wave detector).

A first electromagnetic wave measurement device (refer to FIG. 1) according in the present invention may include the electromagnetic wave generator and the electromagnetic wave detector opposed to each other, may measure the transmitted wave which is the electromagnetic wave generated from the electromagnetic wave generate, and has transmitted through the specimens, and may monitor a spectrum change of the transmitted wave, or an amplitude attenuation or the delay time change of a transmitted pulse caused by the adhesive, thereby detecting the defective joint.

A second electromagnetic wave measurement device according to the present invention (refer to FIG. 2) may measure a reflected wave from the specimens, and a transmitted and reflected wave which has transmitted through the specimens, and then is further reflected by a rear surface reflective mirror or a metal plate, and may monitor an amplitude attenuation, a delay time, or a spectrum change of the transmitted and reflected wave from the rear surface reflective mirror or the metal plate caused by the adhesive, thereby detecting the defective joint.

The second magnetic wave measurement device (refer to FIG. 2) according to the present invention may monitor an intensity of the transmitted and reflected wave from the rear surface reflective mirror or the metal plate normalized by considering a surface reflectance and an interface reflectance of the specimens, thereby inspecting the defective joint.

The second electromagnetic wave measurement device (refer to FIG. 2) according to the present invention may monitor an interface reflection intensity normalized by considering the surface reflectance of the specimens, thereby carrying out an inspection of detecting the defective joint.

According to the present invention, an electromagnetic wave measurement device includes: an electromagnetic wave output device that outputs an electromagnetic wave having a frequency equal to or more than 0.01 [THz] and equal to or less than 100 [THz] toward a sample acquired by adhering a plurality of specimens to each other by an adhesive; and an electromagnetic wave detector that detects a transmitted electromagnetic wave, which is the electromagnetic wave having transmitted through the sample, wherein whether a joint by the adhesive is excellent or not is determined based on the detected transmitted electromagnetic wave.

According to the thus constructed electromagnetic wave measurement device, an electromagnetic wave output device outputs an electromagnetic wave having a frequency equal to or more than 0.01 [THz] and equal to or less than 100 [THz] toward a sample acquired by adhering a plurality of specimens to each other by an adhesive. An electromagnetic wave detector detects a transmitted electromagnetic wave, which is the electromagnetic wave having transmitted through the sample. The electromagnetic wave measurement device determines whether a joint by the adhesive is excellent or not based on the detected transmitted electromagnetic wave.

According to the electromagnetic wave measurement device of the present invention, the transmitted electromagnetic wave may be a pulse.

According to the electromagnetic wave measurement device of the present invention, whether the joint by the adhesive is excellent or not may be determined based on a temporal waveform of the defected transmitted electromagnetic wave.

According to the electromagnetic wave measurement device of the present invention, whether the joint by the adhesive is excellent or not may be determined based on a peak of the temporal waveform of the detected transmitted electromagnetic wave.

According to the electromagnetic wave measurement device of the present invention, the joint by the adhesive may be determined to be excellent if the peak of the temporal waveform of the detected transmitted electromagnetic wave is less than a threshold.

According to the electromagnetic wave measurement device of the present invention, the threshold may be set to be less than a peak of a temporal waveform of a transmitted electromagnetic wave, which is the electromagnetic wave having transmitted through the plurality of specimens piled on each other without be adhered to each other by the adhesive.

According to the electromagnetic wave measurement device of the present invention, whether the joint by the adhesive is excellent or not may be determined based on a time point at which the temporal waveform of the detected transmitted electromagnetic wave presents the peak.

According to the electromagnetic wave measurement device of the present invention, the joint by the adhesive may be determined to be excellent if the time point at which the temporal waveform of the detected transmitted electromagnetic wave presents the peak is later than a threshold.

According to the electromagnetic wave measurement device of the present invention, the threshold may be set to be later than a time point at which a temporal waveform of a transmitted electromagnetic wave, which is the electromagnetic wave having transmitted through the plurality of specimens piled on each other without being adhered to each other by the adhesive, presents a peak.

According to the electromagnetic wave measurement device of the present invention, whether the joint by the adhesive is excellent or not may be determined based on a frequency spectrum of the detected transmitted electromagnetic wave.

According to the electromagnetic wave measurement device of the present invention, whether the joint by the adhesive is excellent of not may be determined based on a frequency component value corresponding to a predetermined frequency of the frequency spectrum of the detected transmitted electromagnetic wave.

According to the electromagnetic wave measurement device of the present invention, the frequency component value may be an absorbance, and the joint by the adhesive may be determined to be excellent if the frequency component value is equal to or more than a threshold.

According to the electromagnetic wave measurement device of the present invention, the threshold may be set to be more than a value corresponding to the predetermined frequency of a frequency spectrum of a transmitted electromagnetic wave, which is the electromagnetic wave having transmitted through the plurality of specimens piled on each other without being adhered to each other by the adhesive.

According to the electromagnetic wave measurement device of the present invention, the frequency component value may be a phase delay, and the joint by the adhesive may be determined to be excellent if the frequency component value is equal to or more than a threshold.

According to the electromagnetic wave measurement device of the present invention, the threshold may be set to be more than a value corresponding to the predetermined frequency of a frequency spectrum of a transmitted electromagnetic wave, which is the electromagnetic wave having transmitted through the plurality of specimens piled on each other without being adhered to each ether by the adhesive.

According to the electromagnetic wave measurement device of the present invention, the frequency component value may be a group delay, and the joint by the adhesive may be determined to be excellent if the frequency component value is less than a threshold.

According to the electromagnetic wave measurement device of the present invention, the threshold may be set to be less than a value contending to the predetermined frequency of a frequency spectrum of a transmitted electromagnetic wave, which is the electromagnetic wave having transmitted through the plurality of specimens piled on each other without being adhered to each other by the adhesive.

According to the present invention, an electromagnetic wave measurement device, includes an electromagnetic wave output device that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; and an electromagnetic wave detector that detects a reflected electromagnetic wave, which is the electromagnetic wave reflected by one of the sample and the reflective body, wherein whether a joint by the adhesive is excellent or not is determined based on the detected reflected electromagnetic wave.

According to the thus constructed electromagnetic wave measurement device, an electromagnetic wave output device outputs an electromagnetic wave having a frequency equal to or more than 0:01 [THz] and equal to or less than 100 [THz] toward a sample acquired by adhering a plurality of specimens to each other by an adhesive and a reflective body arranged behind the sample. An electromagnetic wave detector defects a reflected electromagnetic wave, which is the electromagnetic wave reflected by one of the sample and the reflective body. The electromagnetic wave measurement device determines whether a joint by the adhesive is excellent or not based on the detected reflected electromagnetic wave.

According to the electromagnetic wave measurement device of the present invention, whether the joint by the adhesive is excellent of not may be determined based on a transmittance of the adhesive acquired based on a transmittance of the specimen, an intensity of the detected reflected electromagnetic wave, and an intensity of the electromagnetic wave.

According to the electromagnetic wave measurement device of the present invention, whether the joint by the adhesive is excellent or not may be determined based on the transmittance of the adhesive and an intensity of the electromagnetic wave reflected on an interface between at least one of the specimens and the adhesive.

According to the electromagnetic wave measurement device of the present invention, the joint by the adhesive may be determined to be excellent if the transmittance of the adhesive is less than a threshold.

According to the electromagnetic wave measurement device of the present invention, whether the joint by the adhesive is excellent or not may be determined based on a difference in a time point at which the reflected electromagnetic wave is detected.

According to the present invention, an electromagnetic wave measurement method includes an electromagnetic wave output step that outputs an electromagnetic wave having a frequency equal to or more than 0.01 [THz] and equal to or less than 100 [THz] toward a sample acquired by adhering a plurality of specimens to each other by an adhesive; an electromagnetic wave detecting step that detects a transmitted electromagnetic wave, which is the electromagnetic wave having transmitted through the sample; and a determination step that determine whether a joint by the adhesive is excellent or not based on the detected transmitted electromagnetic wave.

According to the present invention, an electromagnetic wave measurement method includes: an electromagnetic wave output step that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; an electromagnetic wave detecting step that detects a reflected electromagnetic wave, which is the electromagnetic wave reflected by one of the sample and the reflective body; and a determination step that determine whether a joint by the adhesive is excellent or not based on the detected reflected electromagnetic wave.

The present invention is a program of instructions for execution by a computer to perform a measurement process with using an electromagnetic wave measurement device having an electromagnetic output device that outputs an electromagnetic wave having a frequency equal to or more than 0.01 [THz] and equal to or less than 100 [THz] toward a sample acquired by adhering a plurality of specimens to each other by an adhesive and ah electromagnetic wave detector that detects a transmitted electromagnetic wave, which is the electromagnetic wave having transmitted through the sample, the measurement process including: a determination step that determine whether a joint by the adhesive is excellent or not based on the detected transmitted electromagnetic wave.

The present invention is a program of instructions for execution by a computer to perform a measurement process with using an electromagnetic wave measurement device having an electromagnetic wave output device that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; and an electromagnetic wave detector that detects a reflected electromagnetic wave, which is the electromagnetic wave reflected by one of the sample and the reflective body, the measurement process including: a determination step that determine whether a joint by the adhesive is excellent or not based on the detected reflected electromagnetic wave.

The present invention is a computer-readable medium having a program of instructions for execution by a computer to perform a measurement process with using an electromagnetic wave measurement device having an electromagnetic wave output device that outputs an electromagnetic wave having a frequency equal to or more than 0.01 [THz] and equal to or less than 100 [THz] toward a sample acquired by adhering a plurality of specimens to each other by an adhesive and an electromagnetic wave detector that detects a transmitted electromagnetic wave, which is the electromagnetic wave having transmitted through the sample, the measurement process including: a determination step that determine whether a joint by the adhesive is excellent or not based on the detected transmitted electromagnetic wave.

The present invention is a computer-readable medium having a program of instructions for execution by a computer to perform a measurement process with using an electromagnetic wave measurement device having an electromagnetic wave output device that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; and an electromagnetic wave detector that detects a reflected electromagnetic wave, which is the electromagnetic wave reflected by one of the sample and the reflective body, the measurement process including: a determination step that determine whether a joint by the adhesive is excellent or not based on the detected reflected electromagnetic wave.

### BRIEF DESCRIPTION OF DRAWINGS

FIG. 1 is a diagram showing a configuration of a first electromagnetic wave measurement device according to the present invention;

FIG. 2 is a diagram showing a configuration of a second electromagnetic wave measurement device according to the present invention;

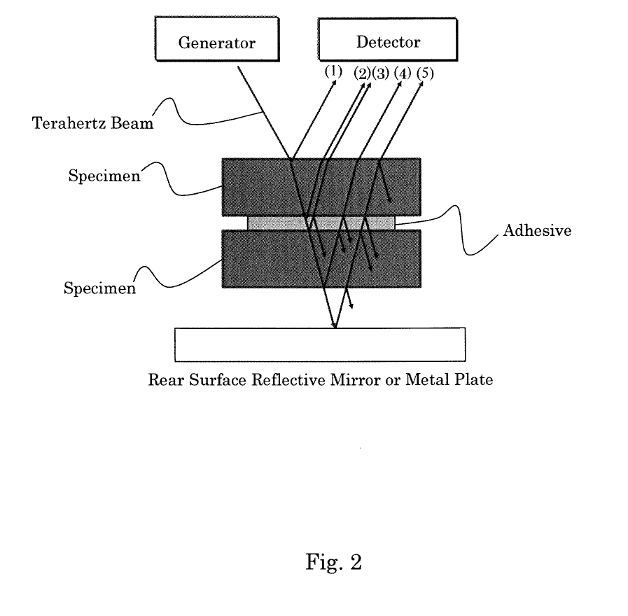

FIG. 3 is a diagram showing a configuration of an electromagnetic wave measurement device according a first embodiment of the present invention;

FIG. 4 is a chart showing a measurement result by the electromagnetic wave measurement device according to the first embodiment of the present invention;

FIG. 5 is a diagram showing the configuration of the electromagnetic wave measurement device according a second embodiment of the present invention;

FIG. 6 is a chart showing the measurement result by the electromagnetic wave measurement device according to the second embodiment of the present invention;

FIG. 7 is a chart illustrating a temporal waveform (denoted by “without adhesive”) of a terahertz pulse which has transmitted through a specimen 1 and a specimen 2 simply piled on each other (without adhesion), and a temporal waveform (denoted by “with adhesive”) of a terahertz pulse which has transmitted through a sample;

FIG. 8 is a chart illustrating an absorbance spectrum (denoted by “without adhesive”) of the terahertz pulse which has transmitted through the specimen 1 and the specimen 2 simply piled on each other (without adhesion), and an absorbance spectrum (denoted by “with adhesive”) of the terahertz wave which has transmitted through the sample;

FIG. 9 is a chart illustrating a phase delay (denoted by “without adhesive”) of the terahertz pulse which has transmitted through the specimen 1 and the specimen 2 simply piled on each other (without adhesion), and a phase delay (denoted by “with adhesive”) of the terahertz wave which has transmitted through the sample;

FIG. 10 is a chart illustrating a group delay (denoted by “without adhesive”) of the terahertz pulse which has transmitted through the specimen 1 and the specimen 2 simply piled on each other (without adhesion), and a group delay (denoted by “with adhesive”) of the terahertz wave which has transmitted through the sample; and

FIG. 11 is a diagram showing an example of the determination for the joint based on the transmittance β of the adhesive.

### MODES FOR CARRYING OUT THE INVENTION

A description will now be given of embodiments of the present invention referring to drawings.

### First Embodiment

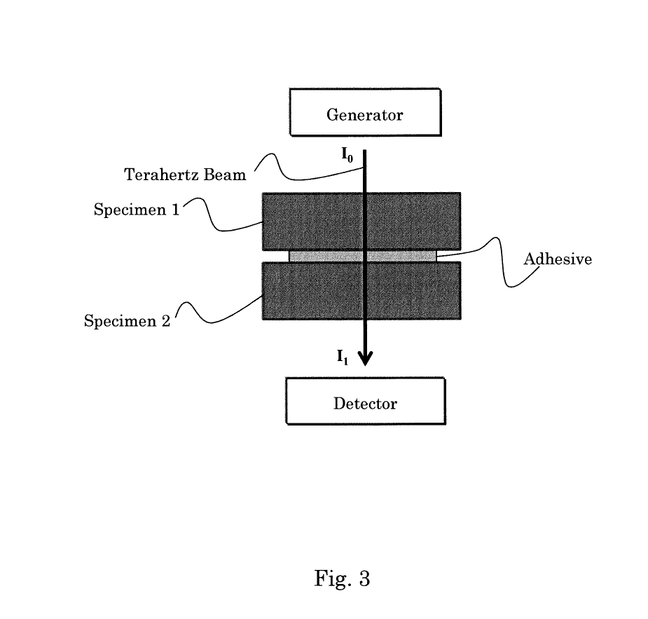

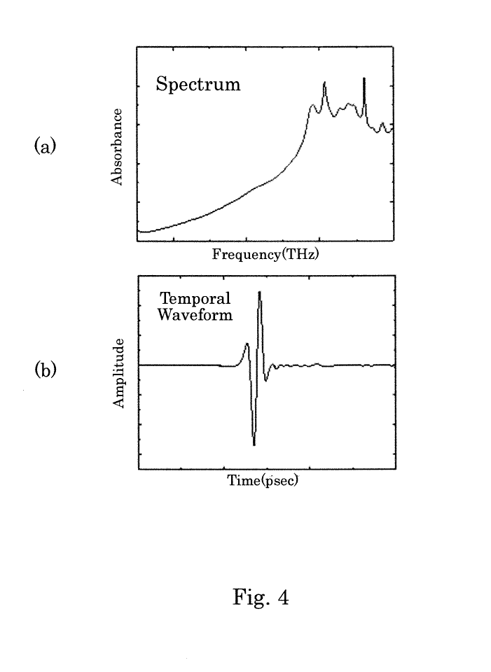

FIG. 3 is a diagram showing a configuration of an electromagnetic wave measurement device according a first embodiment of the present invention. FIG. 4 is a chart showing a measurement result by the electromagnetic wave measurement device according to the first embodiment of the present invention.

The frequency of an electromagnetic wave output toward specimens includes a terahertz wave band (equal to or more than 0.03 [THz] and equal to or less than 10 [THz], for example). According to all embodiments of the present invention, it is assumed that a terahertz wave is employed as an example of the electromagnetic wave.

The electromagnetic wave measurement device according to the first embodiment of the present invention intrudes a terahertz wave generator and a terahertz wave detector.

The generator and the detector of the arranged so as to oppose to each other, and a sample (acquired by adhering the specimen 1 and the specimen 2 to each other by the adhesive) is arranged between the generator and the detector, thereby detecting the terahertz wave which has transmitted through the sample by the detector for measurement.

Mapping analysis for analyzing a portion where the defective joint is generated can be carried out by scanning the sample or the sensor (the electromagnetic wave generator and the electromagnetic wave detector), and by carrying out continuous measurement.

When the terahertz pulse generated from the generator transmits through the sample, an attenuation in pulse amplitude and a delay of the pulse are generated by the specimens and the adhesive.

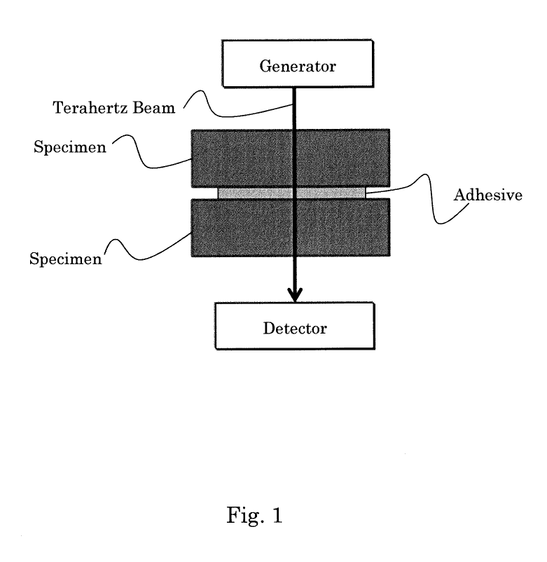

A pulse amplitude attenuation quantity and a pulse delay time (such as a pulse peak delay time) increase as an application amount of the adhesive, and are monitored to detect the defective joint. It should be noted that FIG. 4(b) illustrates a temporal waveform of the terahertz pulse which has transmitted through the sample. FIG. 1 is a chart illustrating a temporal waveform (denoted by “without adhesive”) of the terahertz pulse which has transmitted through the specimen 1 and the specimen 2 simply piled on each other (without adhesion), and a temporal waveform (denoted by “with adhesive”) of a terahertz pulse which has transmitted through the sample.

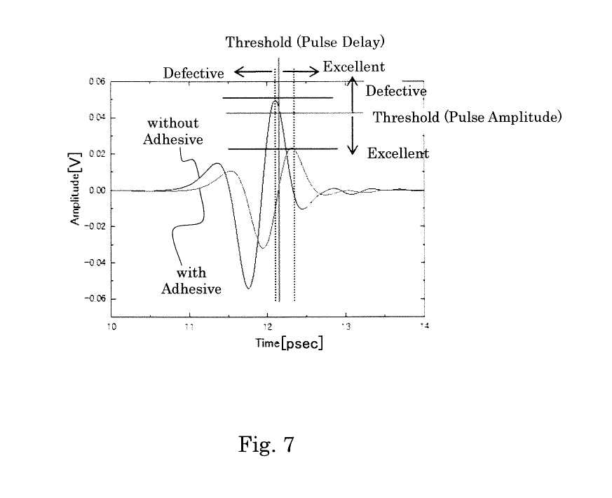

For example, referring to FIG. 7, if the peak of the temporal waveform of the terahertz pulse which has transmitted through the sample is less than a threshold of the pulse amplitude, the joint by the adhesive is determined to be excellent. Moreover, if the peak of the temporal waveform of the terahertz wave which has transmitted through the sample is later than a threshold of the pulse delay, the joint by the adhesive is determined to be excellent.

The peak of the temporal waveform of the terahertz pulse, which has transmitted through the sample and the like, is lower in the case with the adhesive than that in the case without the adhesive due to the attenuation of the pulse amplitude by the adhesive. The threshold for the pulse amplitude is thus determined to fee less than the peak of the temporal waveform in the case without the adhesive (refer to FIG. 7). Moreover, the peak of temporal waveform of the terahertz pulse, which has transmitted through the sample and the like, is delayed more in the case with the adhesive than that in the case without the adhesive due to the delay of the pulse by the adhesive. The threshold for the pulse delay is thus determined to be later than a time point at which the temporal waveform in the case without the adhesive presents the peak (refer to FIG. 7).

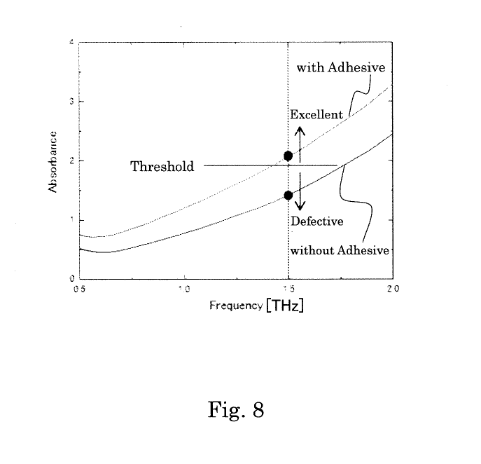

Moreover, the defective joint can be detected by monitoring a change in baseline or an absorption peak of a spectrum obtained by applying the FFT to the terahertz pulse which has transmitted through the sample. FIG. 4(a) shows an absorbance spectrum of the terahertz pulse which has transmitted through the sample. FIG. 8 is a chart illustrating absorbance spectrum (denoted by “without adhesive”) of the terahertz pulse which has transmitted through the specimen 1 and the specimen 2 simply piled on each other (without adhesion), and an absorbance spectrum (denoted by “with adhesive”) of the terahertz wave which has transmitted through the sample;

Referring to FIG. 8, a value obtained by adding a predetermined quantity of absorbance considering an absorption of the terahertz pulse by the adhesive to an absorbance for “without adhesive” at a predetermined frequency (such as 1.5 THz) of the terahertz pulse which has transmitted through the sample is set as a threshold, for example. If “with adhesive”has an absorbance equal to or more than the threshold at the predetermined frequency (such as 1.5 THz), it is determined that the joint is excellent.

Though the pulse peak delay time depends on the application amount of the adhesive, the pulse peak delay time does not depend on a change in intensity of an entrance into the inside of the specimen caused by the surface reflection. Therefore, even if there is a pattern having different surface reflectors caused by printing or the like on specimen surfaces, the defective joint can be detected without an error.

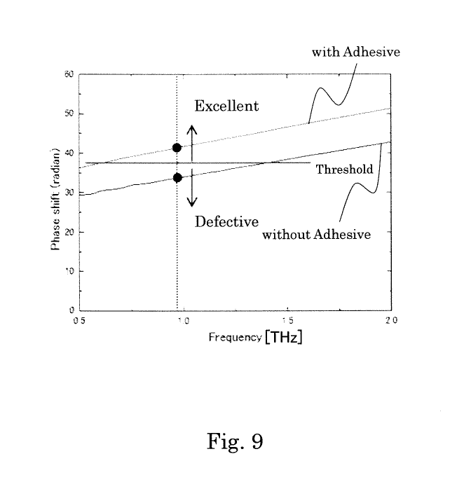

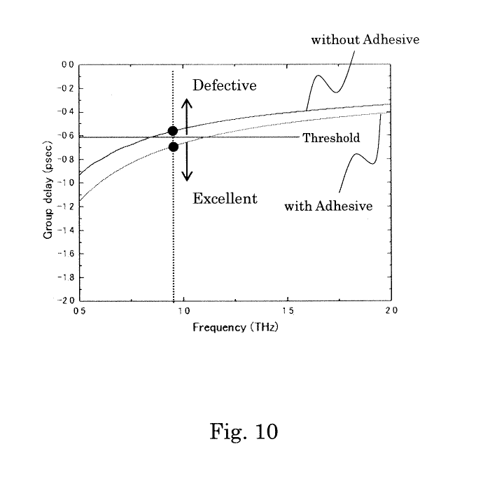

It should be noted that the pulse peak delay time can be evaluated by the phase delay and the group delay. FIG. 9 is a chart illustrating a phase delay (denoted by “without adhesive”) of the terahertz pulse which has transmitted through the specimen 1 and the specimen 2 simply piled on each other (without adhesion), and a phase delay (denoted by “with adhesive”) of the terahertz wave which has transmitted through the sample. FIG. 10 is a chart illustrating a group delay (denoted by “without adhesive”) of the terahertz pulse which has transmitted through the specimen 1 and the specimen 2 simply piled on each other (without adhesion), and a group delay (denoted by “with adhesive”) of the terahertz wave which has transmitted through the sample.

Referring to FIG. 9, a value obtained by adding a predetermined quantity of phase delay considering the delay of the terahertz pulse by the adhesive to a phase delay (phase shift) for “without adhesive” at a predetermined frequency (such as approximately 0.96 THz) of the terahertz pulse which has transmitted through the sample is set as a threshold, for example. If “with adhesive” has a phase delay equal to or more than the threshold at the predetermined frequency (such as approximately 0.96 THz), it is determined that the joint is excellent.

Referring to FIG. 10, a value obtained by subtracting a predetermined quantity of group delay considering a group delay of the terahertz pulse by the adhesive from a group delay for “without adhesive” at a predetermined frequency (such as approximately 0.95 THz) of the terahertz pulse which has transmitted through the sample is set as a threshold, for example. If “with adhesive” has a group delay less than the threshold at the predetermined frequency (such as approximately 0.95 THz), it is determined that the joint is excellent.

Moreover, the terahertz wave is higher in transmittance than near infrared ray, and can enable inspections for wide ranges of the thickness and the type of the specimens and the adhesive. Moreover, the terahertz wave generated in the pulse form can be evaluated in terms of the pulse delay time in addition to the pulse amplitude, resulting in a highly precise inspection considering the information on the structure of the sample.

Further, the terahertz wave can highly precisely inspect the defective joint in the non-contact manner for wide ranges of the thickness and the type of the specimens and the adhesive.

Moreover, the pulse delay time does not depends on the surface reflectance and the interface reflectance, and changes depending on the defective joint, and the defective joint can be inspected independently of the surface reflectance of the specimens.

### Second Embodiment

The electromagnetic wave measurement device according to a second embodiment of the present invention includes the terahertz wave generator and the terahertz wave detector.

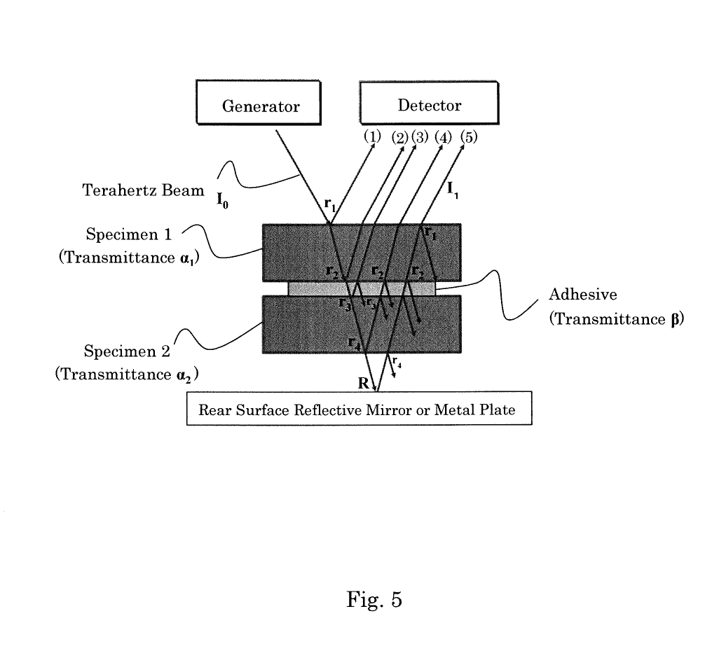

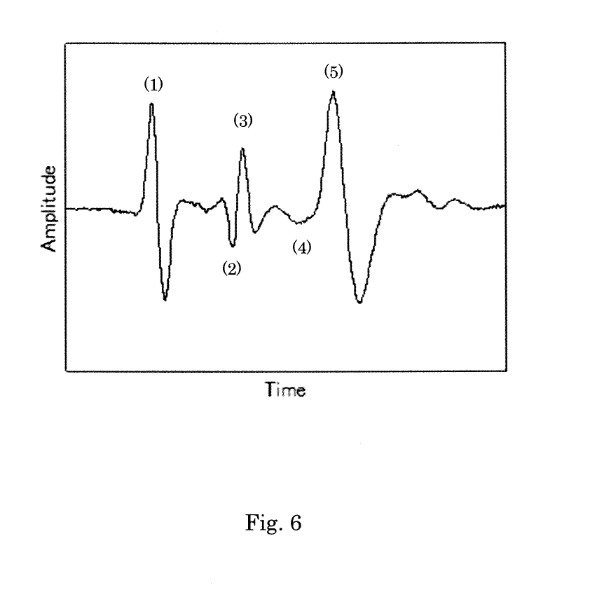

FIG. 5 is a diagram showing the configuration of the electromagnetic wave measurement device according the second embodiment of the present invention. FIG. 6 is a chart showing the measurement result by the electromagnetic wave measurement device according to the second embodiment of the present invention. It should be noted that the adhesive is extremely thin compared with the specimens 1 and 2, and a refraction of the terahertz pulse by the adhesive is thus neglected in the drawing for the sake of illustration in FIG. 5.

The detector is arranged at a position enabling detection of reflections of the terahertz pulse, which is made incident from the generator, from the specimens and from the rear surface reflective mirror or the metal plate (reflective body) arranged on the rear surface of the sample in the magnetic wave measurement device according to the second embodiment of the present invention.

Mapping analysis for analyzing a portion where the defective joint is generated can be carried out by scanning the sample or the sensor (the electromagnetic wave generator and the electromagnetic wave detector), and by carrying out continuous measurement.

When the terahertz pulse is made incident to the sample (acquired by adhering the specimen 1 and the specimen 2 to each other by the adhesive), referring to FIG. 6, a pulse (1) which is reflected by the surface of the sample, a pulse (2) which has transmitted through the specimen 1, and is reflected by an interface between the specimen 1 and the adhesive, a pulse (3) which has transmitted through the specimen 1, the adhesive, and is reflected by an interface between the specimen 2 and the adhesive, a pulse (4) which has transmitted through the specimen 1 and the adhesive, progressed in the specimen 2 and is reflected by the rear surface of the specimen 2, and a pulse (5) which is reflected by the rear surface reflection mirror or the metal plate are detected by the detector.

A detected intensity I1 of the pulse (5) rejected by the rear surface reflection mirror or the metal plate (reflective body) is represented by the following equation by using the allowing parameters.

Intensity of light incident to sample surface: I0

Reflectance of surface of sample: r1

Reflectance of interface between specimen 1 and adhesive: r2

Reflectance of interface between adhesive and specimen 2: r3

Reflectance of rear surface of specimen 2: r4

Reflectance of reflective mirror or metal plate (reflective body): R≠1

Transmittance of specimen 1: α1

Transmittance of specimen 2: α2

Transmittance of adhesive: β

I1=I0×(1·r1)×α1×(1·r2)×β×(1·r3)×α2×(1·r4)×R×(1·r4)×α2×(1·r3)×β×(1·r2)×α1×(1·r1)=I0[α1α2β(1·r1)(1·r2)(1·r3)(1·r4)]²

If the application amount of the adhesive between the specimens changes, β in the equation changes. However, the value of I1 also depends on r1, r2, r3, and r4. Therefore, if there is a pattern different in the surface reflectance r1 on the sample surface, for example, it is difficult to determine whether the change in I1 is caused by the adhesive or the surface reflectance.

However, the surface reflectances r1, r2, r3 and r4 can be calculated by using the intensities of the reflected pulses (1), (2), (3), and (4) from the surfaces and the interfaces observed in reflected wave forms. Thus, the r1, r2, r3 and r4 can be derived simultaneously with the observation of I1.

Moreover, I0 can be obtained by the detector detecting an intensity of the terahertz pulse which is emitted from the generator, and then reflected by a reference mirror (not shown).

Therefore, the transmittance β of the adhesive can be acquired by processing the following equation for I1. On this occasion, α1 has a constant value if the specimen 1 is made of a uniform material, and has a uniform thickness. Similarly, α2 has a constant value if the specimen 2 is made of a uniform material, and has a uniform thickness.

β=(I1/I0)^{0.5}/[(1·r1)(1·r2)(1·r3)(1·r4)×α1×α2 ] (1)

The defective joint can be detected by monitoring the value of β acquired based on Equation (1). In other words, it is possible to determine whether the joint by the adhesive is excellent or not baaed on the transmittance β of the adhesive acquired based on the transmittances α1 and α2 of the specimens 1 and 2, the intensity I1 of the detected reflected electromagnetic wave, the surface reflectances r1, r2, r3, and r4 calculated based on the intensities of the reflected pulses (1), (2), (3), and (4) (reflected electromagnetic waves), and the intensity I0 of the electromagnetic wave.

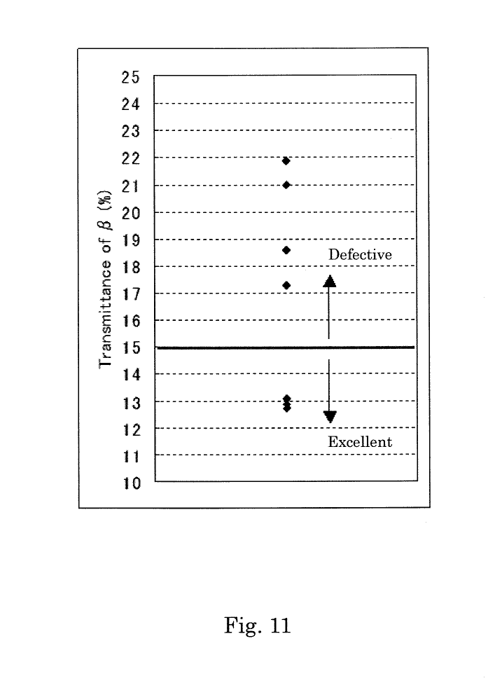

FIG. 11 is a diagram showing an example of the determination for the joint based on the transmittance β of the adhesive. Referring to FIG. 11, the joint is determined to be defective if the transmittance β of the adhesive is more than the threshold (such as 15%), and is determined to be excellent if the transmittance β is less than the threshold.

If α1 or α2 can be approximated to 1, the processing of a multiplication by α1 or α2 may be omitted in Equation (1). If r1, r2, r3, or r4 is sufficiently smaller than 1, the processing of a multiplication by 1·r1, 1·r2, 1·r3 or 1·r4 may be omitted in Equation (1).

Moreover, since it is enough to acquire a variation in β during the measurement, if α1 or α2 does not change during the measurement, the processing of the multiplication by α1 or α2 may be omitted in Equation (1). Similarly, if r1, r2, r3, or r4 does not change during the measurement, the processing of the multiplication by 1·r1, 1·r2, 1·r3 or 1·r4. It may be omitted in Equation (1).

Moreover, if the air enters into the interface between the adhesive and the specimen 1 or the interface between the adhesive and the specimen 2, the intensity of either one of or both of the pulse (2) and the pulse (3) increases. The defective joint can thus be detected by monitoring β acquired based on Equation (1) as well as the intensities of the pulse (2) and the pulse (3) (therefore, the reflectance of the interface between the adhesive and the specimen 1, and the reflectance of the interface between the adhesive and the specimen 2).

Further, information on the adhesive (such as the defective joint by the adhesive) can be extracted by monitoring the delay time of each of the reflected pulse (such as a time of delay of each of the pulses (2), (3), (4) and (5) with respect to the pulse (1)).

A time difference (delay time) between the pulse (1) and the pulse (5) increases depending on the applied quantity of the adhesive between the specimen 1 and the specimen 2, and the defective joint can be detected by monitoring the delay time.

According to the second embodiment, there are obtained the same effects as in the first embodiment.

Further, since the terahertz pulse passes through the adhesive twice according to the second embodiment, the pulse amplitude attenuation and the pulse delay time change are doubled compared with the simple transmission measurement, and even if the amplitude attenuation and the delay time change by the adhesive or the specimens are small, the defective joint can be highly sensitively detected.

It should be noted that it is conceivable to inspect a foreign matter inside a specimen having surface reflectance patterns different from each other.

Moreover, the above-described embodiment may be realized in the following manner. A computer is provided with a CPU, a hard disk, and a media, (such as a floppy disk (registered trade mark) and a CD-ROM) reader, and the media reader is caused to read a medium recording a program realizing the above-described respective components, thereby installing the program on the hard disk. This method may also realize the above-described functions.

1. An electromagnetic wave measurement device, comprising:
an electromagnetic wave output device that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; and
an electromagnetic wave detector that detects a reflected electromagnetic wave, which is the electromagnetic wave reflected by one of the sample and the reflective body,
wherein whether a joint by the adhesive is excellent or not is determined based on the detected reflected electromagnetic wave.

2. The electromagnetic wave measurement device according to claim 1, whether the joint by the adhesive is excellent or not is determined based on a transmittance of the adhesive acquired based on a transmittance of the specimen, an intensity of the detected reflected electromagnetic wave, and an intensity of the electromagnetic wave.

3. The electromagnetic wave measurement device according to claim 2, wherein whether the joint by the adhesive is excellent or not is determined based on the transmittance of the adhesive and an intensity of the electromagnetic wave reflected on an interface between at least one of the specimens and the adhesive.

4. The electromagnetic wave measurement device according to claim 2, wherein the joint by the adhesive is determined to be excellent if the transmittance of the adhesive is less than a threshold.

5. The electromagnetic wave measurement device according to claim 1, wherein whether the joint by the adhesive is excellent or not is determined based on a difference in a time point at which the reflected electromagnetic wave is detected.

6. An electromagnetic wave measurement method, comprising:
an electromagnetic wave output step that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample;
an electromagnetic wave detecting step that detects a reflected electromagnetic wave, which is the electromagnetic wave reflected by one of the sample and the reflective body; and
a determination step that determine whether a joint by the adhesive is excellent or not based on the detected reflected electromagnetic wave.

7. (canceled)

8. A computer-readable medium having a program of instructions for execution by a computer to perform a measurement process with using an electromagnetic wave measurement device having an electromagnetic wave output device that outputs an electromagnetic wave having a frequency equal to or more than 0.01 [THz] and equal to or less than 100 [THz] toward a sample acquired by adhering a plurality of specimens to each other by an adhesive and a reflective body arranged behind the sample; and an electromagnetic wave detector that detects a reflected electromagnetic wave, which is the electromagnetic wave reflected by one of the sample and the reflective body, said measurement process comprising:
a determination step that determine whether a joint by the adhesive is excellent or not based on the detected reflected electromagnetic wave.
